(19) United States
(12) Patent Application Publication
(10) Pub. No.: US 2019/0252684 A1
(43) Pub. Date: Aug. 15, 2019

(54) ANODE COMPOSITION, METHOD FOR PREPARING ANODE AND LITHIUM ION BATTERY

(71) Applicant: Robert Bosch GmbH, Stuttgart (DE)

(72) Inventors: Jun Yang, Shanghai (CN); Yitian Bie, Shanghai (CN); Jingjun Zhang, Shanghai (CN); Yuqian Dou, Shanghai (CN)

(21) Appl. No.: 16/310,492

(22) PCT Filed: Jun. 15, 2016
(86) PCT No.: PCT/CN2016/085895

§ 371 Date: Dec. 17, 2018

(51) Int. Cl. H01M 4/62; H01M 10/0525; H01M 4/38; H01M 4/04; H01M 10/0569; H01M 4/134; H01M 10/44

(52) U.S. Cl. CPC H01M 4/621; H01M 10/0525; H01M 4/386; H01M 4/0404; H01M 2004/027; H01M 4/0445; H01M 4/625; H01M 4/134; H01M 10/446; H01M 10/0569

(57) ABSTRACT

Provided is an anode composition for lithium ion batteries, comprising a) a silicon-based active material; and b) a binder, wherein the binder is selected from the group consisting of oxystarch, locust bean gum, tara gum, karaya gum and any combination thereof. Also provided are a process for preparing an anode for lithium ion batteries and a lithium ion battery.

### TECHNICAL FIELD

The present invention relates to an anode composition for lithium ion batteries, a process for preparing an anode for lithium ion batteries, and a lithium ion battery.

### BACKGROUND

Lithium ion batteries have now been widely used in energy storage systems and electric vehicles.

Silicon is a promising active material for electrodes of lithium ion batteries owning to its large theoretical capacity and moderate operating voltage. However, during the lithiation/delithiation processes, silicon undergoes dramatic expansion and contraction. Such huge volumetric change impairs the electrochemical performances of lithium ion batteries.

There is an on-going demand for more attractive and reliable lithium ion batteries.

On the other hand, in the effort to design a high-power battery, the reduction of active material particle size to nano-scale can help shorten the diffusion length of charge carriers, enhance the Li-ion diffusion coefficient, and therefore achieve faster reaction kinetics. However, nano-sized active materials have a large surface area, which results in a high irreversible capacity loss due to the formation of a solid electrode interface (SEI). For silicon oxide based anode, the irreversible reaction during the first lithiation also leads to a large irreversible capacity loss in initial cycle. This irreversible capacity loss consumes Li in the cathode, which decreases the capacity of the full cell.

Even worse, for Si-based anode, repeated volume change during cycling reveals more and more fresh surface on the anode, which leads to continuous growth of SEI. And the continuous growth of SEI continuously consumes Li in the cathode, which results in capacity decay for the full cell.

In order to provide more lithium ions to compensate for an SEI or other lithium consumption during the formation, additional or supplementary Li may be provided by the prelithiation of the anode. If the prelithiation of the anode is conducted, the irreversible capacity loss could be compensated in advance instead of Li consumption from the cathode. This results in higher efficiency and capacity of the cell.

However, a pre-lithiation degree of exact compensation for the irreversible loss of lithium from the anode doesn't help to solve the problem of Li consumption from the cathode during cycling. Therefore, in this case, the cycling performance will not be improved. To compensate for the loss of lithium from the cathode during cycling, an over-prelithiation is conducted in the present invention.

### SUMMARY OF THE INVENTION

After intensive study, the inventors have now developed a novel anode composition for lithium ion batteries, comprising:
a) a silicon-based active material; and
b) a binder, wherein the binder may be selected from the group consisting of oxystarch, locust bean gum, tara gum, karaya gum and any combination thereof.

Optionally, the anode composition according to the present disclosure may further comprise: c) a carbon material, wherein the carbon material may be selected from the group consisting of carbon black, acetylene black, Ketjen black, graphite, graphene, carbon nanotubes, vapour grown carbon fibers and any combination thereof.

In some examples, the anode composition according to the present disclosure may comprise:
a) from 5% to 90% by weight of the silicon-based active material;
b) from 5% to 35% by weight of the binder; and
c) from 0 to 85% by weight of carbon material, wherein the weight percents of each component are based on the total weight of the anode composition.

Also provided is a process for preparing an anode for lithium ion batteries, comprising:
preparing a slurry by mixing all components of the anode composition according to the present disclosure with a solvent; and
applying the slurry onto a current collector.

Also provided is a lithium ion battery, comprising an anode prepared from the anode composition according to the present disclosure, or an anode prepared by the process according to the present disclosure.

Surprisingly, the inventors found that by employing the anode compositions according to the present invention, the lithium ion batteries exhibit excellent electrochemical properties, including cycling performances and rate performances.

In addition, the binders employed in the present disclosure may be readily available from abundant natural sources, making it possible to economically prepare anode compositions at large scale. Furthermore, the whole process for preparing the anode compositions of the present disclosure is easy to be carried out, non-toxic and environmentally-friendly.

These and other features, aspects and advantages of the present disclosure will become evident to those skilled in the art from the following description of various examples taken in conjunction with the accompanying drawings.

### BRIEF DESCRIPTION OF THE DRAWINGS

FIG. 1 compares cycling performances of cells prepared according to some Examples of the present disclosure and a Comparative Example.

FIG. 2 compares rate performances of cells prepared according to some Examples of the present disclosure and some Comparative Examples.

FIG. 3 compares cycling performances of cells prepared according to an Example of the present disclosure and some Comparative Examples.

FIG. 4 compares cycling performances of cells prepared according to an Example of the present disclosure and some Comparative Examples.

FIG. 5 shows TEM images of anodes prepared according to an Example of the present disclosure and some Comparative Examples, wherein the anodes have undergone some cycles under high loading.

FIG. 6 shows the cycling performances of the full cells of Example P1-E1.

FIG. 7 shows the normalized energy densities of the full cells of Example P1-E1.

FIG. 8 shows the cycling performances of the full cells of Example P1-E2.

FIG. 9 shows the normalized energy densities of the full cells of Example P1-E2.

FIG. 10 shows the cycling performances of the full cells of Example P1-E3 with the prelithiation degrees ε of a) 0 and b) 22%.

FIG. 11 shows the discharge/charge curve of the cell of Comparative Example P2-CE1, wherein “1”, “4”, “50” and “100” stand for the 1^{st}, 4^{th}, 50^{th} and 100^{th} cycle respectively.

FIG. 12 shows the discharge/charge curve of the cell of Example P2-E1, wherein “1”, “4”, “50” and “100” stand for the 1^{st}, 4^{th}, 50^{th} and 100^{th} cycle respectively.

FIG. 13 shows the cycling performances of the cells of a) Comparative Example P2-CE1 (dashed line) and b) Example P2-E1 (solid line).

FIG. 14 shows the average charge voltage a) and the average discharge voltage b) of the cell of Comparative Example P2-CE1.

FIG. 15 shows the average charge voltage a) and the average discharge voltage b) of the cell of Example P2-E1.

Reference will now be made to some illustrative examples, and specific language will be used herein to describe the same. It will nevertheless be understood that no limitation of the scope of the disclosure is thereby intended.

### DETAILED DESCRIPTION OF THE INVENTION

Throughout this disclosure, all the scientific and technical terms, unless otherwise indicated, shall have the same meanings as those known to a person skilled in the art. Where there is inconsistency, the definition provided in the present disclosure should be taken.

It should be understood that the detailed description of all materials, processes, examples and drawings are presented for the purposes of illustration, and therefore, unless expressly specified otherwise, are not construed as limitations of the present disclosure.

Herein, the terms “cell” and “battery” may be interchangeably used. The terms “lithium ion cell” or “lithium ion battery” may also be abbreviated to “cell” or “battery”.

Herein, the term “comprising” means that other ingredients or other steps which do not affect the final effect can be included. This term encompasses the terms “consisting of” and “consisting essentially of”. The product and process according to the present disclosure can comprise, consist of, and consist essentially of the essential technical features and/or limitations of the present disclosure described herein, as well as any additional and/or optional ingredients, components, steps, or limitations described herein.

The use of the terms “a”, “an” and “the” and similar referents in the context describing the subject matter of this application (especially in the context of the following claims) are to be construed to cover both the singular and the plural, unless otherwise indicated herein or clearly contradicted by context.

Unless otherwise specified, every numerical range in this context intends to include both endpoints and any numbers and sub-ranges falling within said numerical ranges. Unless specially indicated, all materials and agents used in the present disclosure are commercially available.

Examples of the present disclosure are described in detail as follows.

Component a): Silicon-Based Active Material According to some examples of the present disclosure, the anode composition for lithium ion batteries may comprise a silicon-based active material. Comparing with a carbon-based active material, a silicon-based active material possesses a larger theoretical capacity and a more moderate operating voltage.

The term “active material” as used herein means a material which is able to have lithium ions inserted therein and release lithium ion therefrom during repeated charging/discharging cycles.

The term “silicon-based active material” as used herein means an active material containing silicon. There is no specific limitation to the silicon-based active material, and those which are known for use in lithium ion batteries may be used. In some examples, the silicon-based active material may be selected from the group consisting of silicon, silicon alloys, silicon oxides, silicon/carbon composites, silicon oxide/carbon composites and any combination thereof. In some examples, the silicon alloy may comprise silicon and one or more metals selected from the group consisting of Ti, Sn, Al, Sb, Bi, As, Ge and Pb. In some examples, the silicon oxide may be a mixture of more than one oxides of silicon. For example, the silicon oxide may be represented as SiOₓ, where the average value of x may be from about 0.5 to about 2.

In some examples, the silicon-based active material may be in the form of powders, or may be ground into powders. There is no specific limitation to the particle size of silicon-based active material, and those particle sizes commonly known for silicon-based active material may be used. In some examples, the particle size of silicon-based active material may be nanometer-scale (i.e., ranging from equal to or more than 1 nanometer to less than 1 micrometer) or micrometer-scale (i.e., ranging from equal to or larger than 1 micrometer to less than 1 millimeter). In some examples, the silicon oxide may have a particle size from 50 nm to 15 m, such as from 50 nm to 3 μm.

According to some examples of the present disclosure, the content of the silicon-based active material may be from 5% to 90% by weight, based on the total weight of the anode composition.

### Component b): Binder

According to some examples of the present disclosure, the anode composition may comprise a binder, wherein the binder may be selected from the group consisting of oxystarch, locust bean gum, tara gum, karaya gum and any combination thereof.

Oxystarch, locust bean gum, tara gum and karaya gum are polysaccharides having dendritic structures. It is noted that not all dendritic polysaccharides derived from natural sources are suitable in the present disclosure. The inventors surprisingly found that the specific binders that may be employed in the present disclosure, i.e., oxystarch, locust bean gum, tara gum, karaya gum or their combinations, showed advantageous effects, such as superior adhesive forces, and excellent dispersibilities for carbon materials (if any), and helped to retain good stabilities and integrities of the anodes during volume changes, and thus improved the electrochemical properties of the final cells, including cycling performances and rate performances.

The binders employed in the present disclosure may be prepared from natural sources, and may also be commercially available.

The term “oxystarch” intends to mean a material prepared by partially oxidizing corn starch so that part of the hydroxyl groups in the corn starch are converted into carboxyl groups. The corn starch may be a natural mixture of amylose and amylopectin.

Since silicon has a high affinity for oxygen, an oxide layer will spontaneously form on the surface of silicon upon exposure to air even at room temperature. Therefore, there is usually a natural silicon oxide layer on the surface of the silicon-based active material. The surface layer of silicon oxide contains hydroxyl groups, i.e., silanol groups —Si—OH. The specific dendritic polysaccharides of the present disclosure may simultaneously contain several carboxyl groups and hydroxyl groups in their molecules, and thus may form large amounts of hydrogen bonds between the dendritic polysaccharides and the silicon-based active materials, so as to hold the silicon-based active materials together during volume changes.

In addition, the specific dendritic polysaccharides according to the present disclosure may also possess excellent dispersibilities for carbon materials (if present). Carbon materials generally are hydrophobic. Therefore, for carbon materials that have relatively small particle sizes and large specific areas, it is usually difficult for them to disperse uniformly in binders containing hydroxyl groups and/or carboxyl groups. However, the specific dendritic binders according to the present disclosure surprisingly have excellent dispersibilities for carbon materials, e.g., carbon black (such as super P), and thus help to reach homogenous dispersion of conductive carbon materials in electrodes.

Therefore, the specific dendritic polysaccharides of the present disclosure are particularly suitable for anodes containing both silicon-based active materials and carbon materials, or particularly suitable for anodes containing silicon/carbon composites and/or silicon oxide/carbon composites in the silicon-based active materials.

Meanwhile, the dendritic structures of the specific polysaccharides of the present disclosure may help to form three-dimensional networks, and contribute to the integrity and stability of the anodes. Therefore, by employing the specific dendritic polysaccharides of the present disclosure, the lithium ion batteries exhibit excellent electrochemical properties, including cycling performances and rate performances.

According to some examples of the present disclosure, the content of the dendritic polysaccharide of the present disclosure may be from 5% by weight to 35% by weight, for example, from 7% by weight to 20% by weight, based on the total weight of the anode composition. If the contents of the dendritic polysaccharides fall within the aforementioned ranges, a good balance among electrical conductivity, adhesion property and capacity may be advantageously achieved.

### Component c): Carbon Material

According to some examples of the present disclosure, the anode composition may optionally comprise a carbon material. The carbon material may increase the electrical conductivity and/or dispersibility of the anode composition.

The term “carbon material” as used herein means a material containing carbon. There is no specific limitation to the carbon material, and those which are known for use in lithium ion batteries may be used. In some examples, the carbon material may be selected from the group consisting of carbon black, acetylene black, Ketjen black, graphite, graphene, carbon nanotubes, vapour grown carbon fibers and any combination thereof. In some examples, carbon black may be Super P (e.g., super P commercially available from Timcal, particle size: 20 nm). In some example, graphite may be graphite powder (e.g., particle size: 2-30 μm), and/or graphite flake (e.g., KS6L commercially available from Timcal, particle size: about 6 μm). The carbon materials may be used individually or in any combination. In some examples, Super P, graphite powder and graphite flake may be used in a combination of two or three of them. Super P has a relatively smaller particle size and good electrical conductivity, and may improve the one-dimensional electrical conductivity and one-dimensional dispersibility. Graphite powder and graphite flake have relatively larger particle sizes and good electrical conductivity, and may improve the two-dimensional electrical conductivity, two-dimensional dispersibility and cycling performance.

In some examples, the carbon material may be in the form of powders and/or flakes, or may be ground into powders and/or flakes.

According to some examples of the present disclosure, the content of the carbon material may be from 0% by weight to 85% by weight, based on the total weight of the anode composition.

### Preparation Process of an Anode

There is no specific limitation to the preparation process of the anode. In some examples, the process for preparing an anode for lithium ion batteries may comprise:
preparing a slurry by mixing all components of the anode composition according to the present disclosure with a solvent; and
applying the slurry onto a current collector.

There is no specific limitation to the solvent as used in this disclosure, and those solvents commonly known in cells may be used. In some examples, inorganic solvents (such as water), organic solvents (such as alcohol) or their combinations may be used as the solvent.

The whole process for preparing the anode composition of the present disclosure is easy to be carried out, non-toxic and environmentally-friendly.

### Lithium Ion Battery

The lithium ion battery according to the present invention may comprise an anode prepared from the anode composition according to the present disclosure, or comprising an anode prepared by the process according to the present disclosure.

The lithium ion batteries according to the present disclosure may be used in energy storage systems and electric vehicles.

In general, when the cathode efficiency is higher than the anode efficiency, a prelithiation can effectively increase the cell capacity via increasing the initial Coulombic efficiency. In this case, maximum energy density can be reached. For a cell, in which the loss of lithium during cycling may occur, prelithiation can also improve the cycling performance when an over-prelithiation is applied. The over-prelithiation provides a reservoir of lithium in the whole electrochemical system and the extra lithium in the anode compensates the possible lithium consumption from the cathode during cycling.

In principle, the higher prelithiation degree, the better cycling performance could be achieved. However, a higher prelithiation degree involves a much larger anode.

Therefore, the cell energy density will decrease due to the increased weight and volume of the anode. Therefore, the prelithiation degree should be carefully controlled to balance the cycling performance and the energy density.

The present invention, according to one aspect, relates to a lithium-ion battery comprising a cathode, an electrolyte, and an anode, wherein the anode is prepared from the anode composition according to the present disclosure, or prepared by the process according to the present disclosure, and the initial surface capacity a of the cathode and the initial surface capacity b of the anode satisfy the relation formulae

1<(b·(1−ε)/a)≤1.2 (I),

0<ε≤((a·η₁)/0.6−(a−b·(1−η₂)))/b (II),

where
ε is the prelithiation degree of the anode,
η₁ is the initial coulombic efficiency of the cathode, and
η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” E of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with an embodiment of the lithium-ion battery according to the present invention, the initial surface capacity a of the cathode and the initial surface capacity b of the anode satisfy the relation formulae

1.05≤(b(1−ε)/a)≤1.15 (Ia),

preferably 1.08≤(b·(1−ε)/a)≤1.12 (Ib).

In accordance with another embodiment of the lithium-ion battery according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
c is the depth of discharge (DoD) of the anode.

In particular, c=(b·(1−η₂)−a·(1−η₁))/b, when c=1.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

The present invention, according to another aspect, relates to a method for producing a lithium-ion battery comprising a cathode, an electrolyte, and an anode, wherein the anode is prepared from the anode composition according to the present disclosure, or prepared by the process according to the present disclosure, and said method includes the following steps:
1) prelithiating the active material of the anode or the anode to a prelithiation degree ε, and
2) assembling the anode and the cathode to obtain said lithium-ion battery, characterized in that the initial surface capacity a of the cathode, the initial surface capacity b of the anode, and the prelithiation degree ε satisfy the relation formulae

1<(b·(1−ε)/a)≤1.2 (I),

0<ε≤((a·η₁)/0.6−(a−b·(1−η₂)))/b (II),

where
ε is the prelithiation degree of the anode,
η₁ is the initial coulombic efficiency of the cathode, and
η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

The prelithiation process is not particularly limited. The lithiation of the anode active material substrate can be carried out for example in several different ways. A physical process includes deposition of a lithium coating layer on the surface of the anode active material substrate such as silicon particles, thermally induced diffusion of lithium into the substrate such as silicon particles, or spray of stabilized Li powder onto the anode tape. An electrochemical process includes using silicon particles and a lithium metal plate as the electrodes, and applying an electrochemical potential so as to intercalate Li⁺ ions into the bulk of the silicon particles. An alternative electrochemical process includes assembling a half cell with silicon particles and Li metal foil electrodes, charging the half cell, and disassembling the half cell to obtain lithiated silicon particles.

In accordance with an embodiment of the method according to the present invention, the initial surface capacity a of the cathode and the initial surface capacity b of the anode satisfy the relation formulae

1.05≤(b(1−ε)/a)≤1.15 (Ia),

preferably 1.08≤(b·(1−ε)/a)≤1.12 (Ib).

In accordance with another embodiment of the method according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
c is the depth of discharge (DoD) of the anode.

In particular, c=(b·(1−η₂)−a·(1−η₁))/b, when c=1.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

Prior art prelithiation methods often involve a treatment of coated anode tape. This could be an electrochemical process, or physical contact of the anode with stabilized lithium metal powder. However, these prelithiation procedure requires additional steps to the current battery production method. Furthermore, due to the highly active nature of the prelithiated anode, the subsequent battery production procedure requires an environment with well-controlled humidity, which results in an increased cost for the cell production.

The present invention provides an alternative method of in-situ prelithiation. The lithium source for prelithaition comes from the cathode. During the first formation cycle, by increasing the cut-off voltage of the full cell, additional amount of lithium is extracted from the cathode; by controlling the discharge capacity, the additional lithium extracted from the cathode is stored at the anode, and this is ensured in the following cycles by maintaining the upper cut-off voltage the same as in the first cycle.

The present invention, according to another aspect, relates to a lithium-ion battery comprising a cathode, an electrolyte, and an anode, characterized in that the anode is prepared from the anode composition according to the present disclosure, or prepared by the process according to the present disclosure, and said lithium-ion battery is subjected to a formation process, wherein said formation process includes an initial formation cycle comprising the following steps:
a) charging the battery to a cut off voltage V_{off} which is greater than the nominal charge cut off voltage of the battery, and
b) discharging the battery to the nominal discharge cut off voltage of the battery.

In the context of the present invention, the term “formation process” means the initial one or more charging/discharging cycles of the lithium-ion battery for example at 0.1C, once the lithium-ion battery is assembled. During this process, a stable solid-electrolyte-inter-phase (SEI) layer can be formed at the anode.

In accordance with an embodiment of the formation process according to the present invention, in step a) the battery can be charged to a cut off voltage which is up to 0.8 V greater than the nominal charge cut off voltage of the battery, preferably 0.1˜0.5 V greater than the nominal charge cut off voltage of the battery, more preferably 0.2˜0.4 V greater than the nominal charge cut off voltage of the battery, particular preferably about 0.3 V greater than the nominal charge cut off voltage of the battery.

A lithium-ion battery with the typical cathode materials of cobalt, nickel, manganese and aluminum typically charges to 4.20V±50 mV as the nominal charge cut off voltage. Some nickel-based batteries charge to 4.10V±50 mV In accordance with another embodiment of the formation process according to the present invention, the nominal charge cut off voltage of the battery can be about 4.2 V±50 mV, and the nominal discharge cut off voltage of the battery can be about 2.5 V±50 mV

In accordance with another embodiment of the formation process according to the present invention, the Coulombic efficiency of the cathode in the initial formation cycle can be 40%˜80%, preferably 50%˜70%.

In accordance with another embodiment of the formation process according to the present invention, said formation process further includes one or two or more formation cycles, which are carried out in the same way as the initial formation cycle.

For the traditional lithium-ion batteries, when the battery is charged to a cut off voltage greater than the nominal charge cut off voltage, metallic lithium will be plated on the anode, the cathode material becomes an oxidizing agent, produces carbon dioxide (CO₂), and increases the battery pressure.

In case of a preferred lithium-ion battery defined below according to the present invention, when the battery is charged to a cut off voltage greater than the nominal charge cut off voltage, additional Li⁺ ions can be intercalated into the anode having additional capacity, instead of being plated on the anode.

In case of another preferred lithium-ion battery defined below according to the present invention, in which the electrolyte comprises one or more fluorinated carbonate compounds as a nonaqueous organic solvent, the electrochemical window of the electrolyte can be broadened, and the safety of the battery can still be ensured at a charge cut off voltage of 5V or even higher.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the lithium-ion battery according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r=0.75V_{off}−3.134 (V).

In accordance with another embodiment of the lithium-ion battery according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=−0.7857V_{off}+7.6643V_{off}−18.33 (Va).

In accordance with another embodiment of the lithium-ion battery according to the present invention, the nominal initial surface capacity a of the cathode and the initial surface capacity b of the anode satisfy the relation formulae

1<b·η₂/(a·(1+r)−b·(1−η₂))−ε≤1.2 (I′),

preferably 1.05≤b·η₂/(a·(1+r)−b·(1−η₂))−ε≤1.15 (Ia′),

more preferably 1.08≤b·η₂/(a·(1+r)−b·(1−η₂))−ε≤1.12 (Ib′),

0<ε≤((a·η₁)/0.6−(a−b·(1−η₂)))/b (II),

where
ε is the prelithiation degree of the anode, and
η₂ is the initial coulombic efficiency of the anode.

According to the present invention, the term “prelithiation degree” E of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the lithium-ion battery according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
η₁ is the initial coulombic efficiency of the cathode, and
c is the depth of discharge (DoD) of the anode.

In particular, c=(b·(1−η₂)−a·(1−η₁))/b, when c=1.

In accordance with another embodiment of the lithium-ion battery according to the present invention, the electrolyte comprises one or more fluorinated carbonate compounds, preferably fluorinated cyclic or acyclic carbonate compounds, as a nonaqueous organic solvent.

In accordance with another embodiment of the lithium-ion battery according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the lithium-ion battery according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the lithium-ion battery according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

In accordance with another embodiment of the lithium-ion battery according to the present invention, after being subjected to the formation process, said lithium-ion battery can still be charged to a cut off voltage V_{off}, which is greater than the nominal charge cut off voltage of the battery, and be discharged to the nominal discharge cut off voltage of the battery.

In accordance with another embodiment of the lithium-ion battery according to the present invention, after being subjected to the formation process, said lithium-ion battery can still be charged to a cut off voltage V_{off}, which is up to 0.8 V greater than the nominal charge cut off voltage of the battery, more preferably 0.1˜0.5 V greater than the nominal charge cut off voltage of the battery, particular preferably 0.2˜0.4 V greater than the nominal charge cut off voltage of the battery, especially preferably about 0.3 V greater than the nominal charge cut off voltage of the battery, and be discharged to the nominal discharge cut off voltage of the battery.

The present invention, according to another aspect, relates to a method for producing a lithium-ion battery comprising a cathode, an electrolyte, and an anode, wherein the anode is prepared from the anode composition according to the present disclosure, or prepared by the process according to the present disclosure, and said method includes the following steps:
1) assembling the anode and the cathode to obtain said lithium-ion battery, and 2) subjecting said lithium-ion battery to a formation process, wherein said formation
process includes an initial formation cycle comprising the following steps:
   a) charging the battery to a cut off voltage V_{off} which is greater than the nominal charge cut off voltage of the battery, and
   b) discharging the battery to the nominal discharge cut off voltage of the battery.

In the context of the present invention, the term “formation process” means the initial one or more charging/discharging cycles of the lithium-ion battery for example at 0.1C, once the lithium-ion battery is assembled. During this process, a stable solid-electrolyte-inter-phase (SEI) layer can be formed at the anode.

In accordance with an embodiment of the formation process according to the present invention, in step a) the battery can be charged to a cut off voltage which is up to 0.8 V greater than the nominal charge cut off voltage of the battery, preferably 0.1˜0.5 V greater than the nominal charge cut off voltage of the battery, more preferably 0.2˜0.4 V greater than the nominal charge cut off voltage of the battery, particular preferably about 0.3 V greater than the nominal charge cut off voltage of the battery.

A lithium-ion battery with the typical cathode materials of cobalt, nickel, manganese and aluminum typically charges to 4.20V±50 mV as the nominal charge cut off voltage. Some nickel-based batteries charge to 4.10V±50 mV.

In accordance with another embodiment of the formation process according to the present invention, the nominal charge cut off voltage of the battery can be about 4.2 V±50 mV, and the nominal discharge cut off voltage of the battery can be about 2.5 V±50 mV.

In accordance with another embodiment of the formation process according to the present invention, the Coulombic efficiency of the cathode in the initial formation cycle can be 40%˜80%, preferably 50%˜70%.

In accordance with another embodiment of the formation process according to the present invention, said formation process further includes one or two or more formation cycles, which are carried out in the same way as the initial formation cycle.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the method according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r=0.75V_{off}−3.134 (V).

In accordance with another embodiment of the method according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=−0.7857V_{off}²+7.6643V_{off}−18.33 (Va).

In accordance with another embodiment of the method according to the present invention, the nominal initial surface capacity a of the cathode and the initial surface capacity b of the anode satisfy the relation formulae

1<b·η₂/(a·(1+r)−b·(1−η₂))−ε≤1.2 (I′),

preferably 1.05≤b·η₂/(a·(1+r)−b·(1−η₂))−ε≤1.15 (Ia′),

more preferably 1.08≤b·η₂/(a·(1+r)−b·(1−η₂))−ε≤1.12 (Ib′),

0<ε≤((a·η₁)/0.6−(a−b·(1−η₂)))/b (II),

where
ε is the prelithiation degree of the anode, and
η₂ is the initial coulombic efficiency of the anode.

According to the present invention, the term “prelithiation degree” E of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the method according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
η₁ is the initial coulombic efficiency of the cathode, and
c is the depth of discharge (DoD) of the anode.

In particular, ε=(b·(1−η₂)−a·(1−η₁))/b, when c=1.

In accordance with another embodiment of the method according to the present invention, the electrolyte comprises one or more fluorinated carbonate compounds, preferably fluorinated cyclic or acyclic carbonate compounds, as a nonaqueous organic solvent.

In accordance with another embodiment of the method according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the method according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the method according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

### EXAMPLES

### Materials

Nano silicon particles: silicon-based active material, 50-200 nm, available from Alfa-Aesar.

Karaya gum: dendritic polysaccharide, binder, available from Aladdin.

Oxystarch: dendritic polysaccharide, binder, available from Dongguan Dongmei Starch Co., Ltd., China.

Locust bean gum: dendritic polysaccharide, binder, available from Aladdin.

Tara gum: dendritic polysaccharide, binder, available from Aladdin.

Sodium carboxymethyl cellulose (CMC): linear polysaccharide, binder, available from Aladdin.

Sodium alginate (SA): linear polysaccharide, binder, available from Aldrich.

Super P: carbon black, carbon material, about 20 nm, available from Timcal.

KS6L: graphite flake, carbon material, about 6 μm, available from Timcal.

Graphite powder: carbon material, about 2-10 jam, available from SHENZHEN KEJING STAR TECHNOLOGY CO.

ET20-26: polyethylene (PE), separator, available from ENTEK.

### Example 1

### [Preparation of an Anode]

600 mg nano silicon particles were mixed with 200 mg Super P (SP) and 200 mg karaya gum (KG) in water to obtain a slurry. Herein, the weight ratio of Si:SP:KG was 6:2:2. After stirring for 4 h, the resultant slurry was coated onto a Cu foil, and then was dried at 70° C. in vacuum for 8 h. Finally, the coated Cu foil was cut into several Φ12 mm anodes.

### [Preparation of a Cell]

A coin cell (CR2016) was assembled in an Argon-filled glovebox (MB-10 compact, MBraun) by using the anode obtained above. A Li metal foil was used as a counter electrode. 1M LiPF₆ in FEC/EC/DMC (1:5:5 by volume, a mixture of fluoroethylene carbonate (FEC), ethylene carbonate (EC) and dimethyl carbonate (DMC)) was used as an electrolyte. ET20-26 was employed as a separator.

### Example 2

Anodes and cells were prepared in the same way as described above for Example 1, except that 200 mg oxystarch (OS) was used instead of 200 mg karaya gum (KG).

### Example 3

Anodes and cells were prepared in the same way as described above for Example 1, except that 200 mg locust bean gum was used instead of 200 mg karaya gum (KG).

### Example 4

Anodes and cells were prepared in the same way as described above for Example 1, except that 200 mg tara gum was used instead of 200 mg karaya gum (KG).

### Example 5

Anodes and cells were prepared in the same way as described above for Example 1, except that 400 mg nano silicon particles, 250 mg nano graphite powder, 150 mg KS6L, 50 mg Super P (SP) and 150 mg karaya gum (KG) were mixed together in water to obtain a slurry.

### Comparative Example 1

Anodes and cells were prepared in the same way as described above for Example 1, except that 200 mg sodium carboxymethyl cellulose (CMC) was used instead of 200 mg karaya gum (KG).

### Comparative Example 2

Anodes and cells were prepared in the same way as described above for Example 1, except that 200 mg sodium alginate (SA) was used instead of 200 mg karaya gum (KG).

### Comparative Example 3

Anodes and cells were prepared in the same way as described above for Example 5, except that 150 mg sodium carboxymethyl cellulose (CMC) was used instead of 150 mg karaya gum (KG).

### Comparative Example 4

Anodes and cells were prepared in the same way as described above for Example 5, except that 150 mg sodium alginate (SA) was used instead of 150 mg karaya gum (KG).

### Example 6

40 mg Super P (SP) and 40 mg karaya gum (KG) were mixed with 2.6 ml water to obtain a slurry. Herein, the weight ratio of SP:KG was 1:1. After stirring for about 3 to 4 h, the resultant slurry was coated onto a Cu foil, and then was dried at 60° C. in vacuum for 3 to 4 h. The coated Cu foil was then observed with naked eyes.

### Comparative Example 5

A coated Cu foil was prepared in the same way as described above for Example 6, except that 40 mg sodium carboxymethyl cellulose (CMC) was used instead of 40 mg karaya gum (KG).

### Comparative Example 6

A coated Cu foil was prepared in the same way as described above for Example 6, except that 40 mg sodium alginate (SA) was used instead of 40 mg karaya gum (KG).

### [Evaluation Tests]

### [Electrochemical Effects of Different Binders]

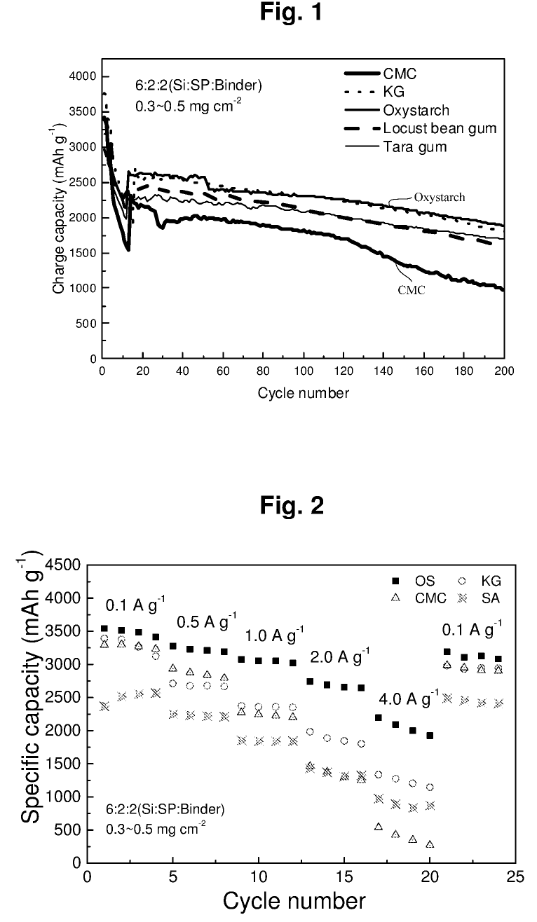

FIG. 1 compares the cycling performances of the cells of Example 1 (containing KG), Example 2 (containing OS), Example 3 (containing locust bean) and Example 4 (containing tara gum) with Comparative Example 1 (containing CMC).

Specifically, the cycling performance of each cell was evaluated on a LAND battery test system (Wuhan Kingnuo Electronics Co., Ltd., China) at 25° C. Each cell was discharged/charged within a voltage range of from 0.01 to 1.2V (vs Li/Li⁺) and at 0.1 A g⁻¹ for the 1^{st} and 2^{nd} cycles, at 0.3 A g⁻¹ for the 3^{rd} and 4^{th} cycles, and at a constant current density of 1.5 A g⁻¹ for the following cycles. The mass loading of the nano silicon particles in each anode of the cells is 0.3 to 0.5 mg/cm².

The 1^{st} and 5^{th} charge capacities as well as capacity retentions of these five cells are summarized in Table 1 below.

TABLE 1

| | | | | Ratio of Capacity | |
|---|---|---|---|---|---|
| | | 1st charge | 5th charge | at 1.5 A g⁻¹/ | |
| | | capacity-0.1 A | capacity-1.5 A g⁻¹ | Capacity at 0.1 A | Capacity retention |
| No. | Binder | g⁻¹ (mAh g⁻¹) | (mAh g⁻¹) | g⁻¹ | after 150 cycles |
| Example 1 | KG | 3769 | 2865 | 76% | 73% |
| Example 2 | OS | 2962 | 2602 | 88% | 82% |
| Example 3 | Locust bean | 3414 | 2577 | 75% | 72% |
| | gum | | | | |
| Example 4 | Tara gum | 3186 | 2448 | 77% | 77% |
| Comparative | CMC | 3390 | 2275 | 67% | 58% |
| Example 1 | | | | | |

By referring to FIG. 1 and Table 1, it can be seen that Examples 1 to 4, which employed dendritic polysaccharides and formed three-dimensional networks, showed higher capacities and better stabilities than Comparative Example 1, wherein Comparative Example 1 employed linear polysaccharide and formed linear networks. The elastic natures of chair-to-boat conformation in α-linkages of KG and OS backbones may accommodate the volume changes of silicon during repeated charge/discharge cycles, and contribute to better cycling performances. Particularly, when increasing the current density from 0.1 A g⁻¹ (e.g. the 1^{st} cycle) to 1.5 A g⁻¹ (e.g. the 5^{th} cycle), Examples 1 to 4 exhibited higher capacity retentions than Comparative Example 1.

FIG. 2 further compares the rate performances of the cells of Example 1 (containing KG), Example 2 (containing OS) with Comparative Example 1 (containing CMC) and Comparative Example 2 (containing SA).

Specifically, the rate performance of each cell was evaluated on a LAND battery test system (Wuhan Kingnuo Electronics Co., Ltd., China) at 25° C. Each cell was discharged/charged within the voltage range of from 0.01 to 1.2V (vs Li/Li⁺) at varying current densities, i.e., at 0.1 A g⁻¹ for the 1^{st} to 4^{th} cycles, at 0.5 A g⁻¹ for the 5^{th} to 8^{th} cycles, at 1.0 A g⁻¹ for the 9^{th} to 12^{th} cycles, at 2.0 A g⁻¹ for the 13^{th} to 16^{th} cycles, at 4.0 A g⁻¹ for the 17^{th} to 20^{th} cycles, and 0.1 A g⁻¹ for the 21^{st} to 24^{th} cycles. The mass loading of the nano silicon particles in each anode of the cells is about 0.3 to 0.5 mg/cm² (about 0.4 mg/cm²).

It can be clearly seen that the rate performances of the cells in Examples 1 and 2 were significantly better than those in Comparative Examples 1 and 2. The rate performance differences between the cells in the Examples and those in the Comparative Examples were more significant at relatively higher current densities. For example, at a current density of 4.0 A g⁻¹, the capacity of Oxystarch in Example 2 was as high as 2500 mAh g⁻¹, while the capacity of CMC in Comparative Example 1 was lower than 500 mAh g⁻¹.

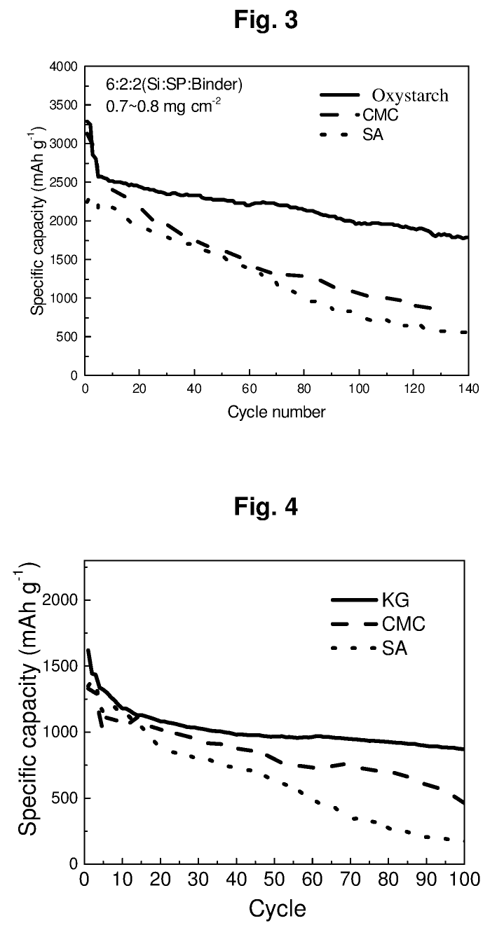

FIG. 3 compares the cycling performances of the cells of Example 2 (containing OS) with Comparative Example 1 (containing CMC) and Comparative Example 2 (containing SA).

The cycling performance of each cell was evaluated on a LAND battery test system (Wuhan Kingnuo Electronics Co., Ltd., China) at 25° C. Each cell was discharged/charged within a voltage range of from 0.01 to 1.2V (vs Li/Li⁺) and at 0.1 A g⁻¹ for the 1^{st} and 2^{nd} cycles, at 0.3 A g⁻¹ for the 3^{rd} and 4^{th} cycles, and at a constant current density of 0.5 A g⁻¹ (lithiation) and 2 A g⁻¹ (delithiation) for the following cycles.

The mass loading of nano silicon particles was 0.7 to 0.8 mg/cm² for the Example and Comparative Examples in FIG. 3, which was higher than the mass loading of 0.3 to 0.5 mg/cm² in FIGS. 1 and 2. When the mass loading of active material was increased, the electrode became easier to crack. However, the cell of Example 2 (OS) exhibited relatively high capacities and excellent cycling stability. In contrast, the cycling performances of the cells in Comparative Example 1 and Comparative Example 2 (CMC and SA) were inferior.

FIG. 4 compares the cycling performances of the cells of Example 5 (containing KG), with Comparative Example 3 (containing CMC) and Comparative Example 4 (containing SA).

The cycling performance of each cell was evaluated on a LAND battery test system (Wuhan Kingnuo Electronics Co., Ltd., China) at 25° C. Each cell was discharged/charged within a voltage range of from 0.01 to 1.2V (vs Li/Li⁺) and at 0.1 A g⁻¹ for the 1^{st} to 3^{rd} cycles, and at a constant current density of 0.5 A g⁻¹ (lithiation) and 1.0 A g⁻¹ (delithiation) for the following cycles. The mass loading of the coating layer in each anode of the cells is about 2.0 to 2.3 mg/cm².

The cells in Example 5, Comparative Example 3 and Comparative Example 4 employed a mixture of SP, graphite powder and graphite flake (KS6L) as the carbon material. By referring to FIG. 4, it can be seen that Example 5, which employed dendritic polysaccharides (i.e., KG) and formed three-dimensional networks, showed better cycling performance than Comparative Examples 3 and 4 (CMC and SA), which employed linear polysaccharides and formed linear networks. In addition, the improved cycling performance of Example 5 may also be attributed to good dispersion of conductive carbon materials in dendritic polysaccharides (i.e., KG), which leads to good conductive networks within the electrode. In contrast, the cycling performance of the cell in Comparative Example 4 (SA) was the worst, partially due to the poor dispersibility of carbon material in SA. The following test further compared the dispersibilities of carbon material in different binders.

### [Dispersibilities of Carbon Materials in Different Binders]

As mentioned above, the coated Cu foils in Example 6 (containing KG and Super P), Comparative Example 5 (containing CMC and Super P) and Comparative Example 6 (containing SA and Super P) were observed with naked eyes.

It was found that the coated Cu foil in Example 6 was in uniform dark color, indicating that Super P was uniformly dispersed in the anode composition. In contrast, the coated Cu foil in Comparative Example 6 was in light color and not uniform, indicating that Super P was not uniformly dispersed in the anode composition. It can be seen that SA does not permit carbon material to uniformly disperse therein. In contrast, the specific dendritic polysaccharides of the present disclosure may uniformly disperse both silicon-based active materials and carbon materials therein.

Therefore, the specific dendritic polysaccharides of the present disclosure may be particularly suitable for anodes containing both silicon-based active materials and carbon materials, or particularly suitable for anodes containing silicon/carbon composites and/or silicon oxide/carbon composites in the silicon-based active materials.

### [Adhesive Forces of Different Binders—Peeling Tests]

FMT-310 force tester (available from ALLURIS Company) was used to measure the adhesive forces of the anodes prepared in Examples 1 and 2, as well as Comparative Examples 1 and 2. A transparent sticky tape with a width of 2 cm was attached to each of these four anodes. The attached anode was then clamped onto the upper edge and the lower edge of the force tester. Subsequently, the attached surface of the anode was pulled in a direction vertical to the anode surface at a constant speed of 100 mm/minute, with the pulling force being slowly increased. Once the tape was pulled away from the Cu foil, the maximum pulling force during the pulling process was recorded as the adhesive force (unit: N) in the following Table 2.

TABLE 2

| | | | Comparative | Comparative |
|---|---|---|---|---|
| | Example 1- | Example 2- | Example 1- | Example 2- |
| | KG | OS | CMC | SA |
| Adhesive | 4.361 | 3.022 | 2.879 | 1.288 |
| Force (N) | | | | |

It can be seen that the dendritic polysaccharides in Examples 1 and 2 (KG and OS) showed significantly improved adhesive forces than linear polysaccharides in Comparative Examples 1 and 2 (CMC and SA).

### [Integrity Retention of Different Binders]

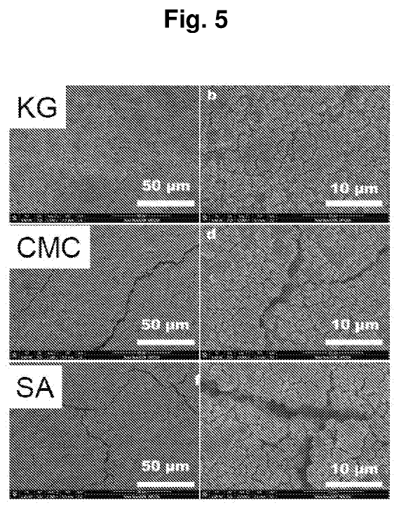

FIG. 5 shows TEM images of the anodes prepared according to Example 1 (containing KG), Comparative Example 1 (containing CMC) and Comparative Example 2 (containing SA), wherein these anodes have undergone 100 cycles under high loading as indicated in FIG. 4.

By referring FIG. 5, it can be seen that after being charged/discharged at high loading, the anode of Example 1 retained good morphological integrity, while the anodes of Comparative Examples 1 and 2 had significant cracks on the anode surfaces.

### Examples P1 for Prelithiation

Active material of the cathode: NCM-111 from BASF, and HE-NCM prepared according to the method as described in WO 2013/097186 A1;

Active material of the anode: a mixture (1:1 by weight) of silicon nanoparticle with a diameter of 50 nm from Alfa Aesar and graphite from Shenzhen Kejingstar Technology Ltd.;

Carbon additives: flake graphite KS6L and Super P Carbon Black C65 from Timcal; Binder: PAA, Mv=450,000, from Sigma Aldrich;

Electrolyte: 1M LiPF₆/EC(ethylene carbonate)+DMC(dimethyl carbonate) (1:1 by volume);

Separator: PP/PE/PP membrane Celgard 2325.

### Example P1-E1

At first anode/Li half cells were assembled in form of 2016 coin cell in an Argon-filled glove box (MB-10 compact, MBraun), wherein lithium metal was used as the counter electrode. The assembled anode/Li half cells were discharged to the designed prelithiation degree E as given in Table P1-E1, so as to put a certain amount of Li⁺ ions in the anode, i.e., the prelithiation of the anode. Then the half cells were disassembled. The prelithiated anode and NCM-111 cathode were assembled to obtain 2032 coin full cells. The cycling performances of the full cells were evaluated at 25° C. on an Arbin battery test system at 0.1C for formation and at 1C for cycling.

TABLE P1-E1

| Group | a | η₁ | b | η₂ | ε | c | x | η_{F} | Life |
|---|---|---|---|---|---|---|---|---|---|
| G0 | 2.30 | 90% | 2.49 | 87% | 0 | 1.00 | 1.08 | 83% | 339 |
| G1 | 2.30 | 90% | 2.68 | 87% | 5.6% | 0.99 | 1.10 | 86% | 353 |
| G2 | 2.30 | 90% | 3.14 | 87% | 19.5% | 0.83 | 1.10 | 89% | 616 |
| G3 | 2.30 | 90% | 3.34 | 87% | 24.3% | 0.77 | 1.10 | 88% | 904 |
| G4 | 2.30 | 90% | 3.86 | 87% | 34.6% | 0.66 | 1.10 | 89% | 1500 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

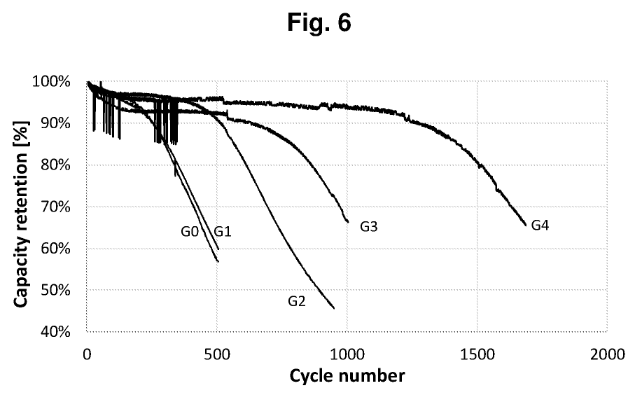

FIG. 6 shows the cycling performances of the full cells of Groups G0, G1, G2, G3, and G4 of Example P1-E1.

In case of Group G0 with a prelithiation degree E=0, the capacity of the full cell was decreased to 80% after 339 cycles.

In case of Group G1 with a prelithiation degree of 5.6%, the prelithiation amount was only enough to compensate the irreversible Li loss difference between the cathode and the anode. Therefore, the initial Coulombic efficiency was increased from 83% to 86%, while no obvious improvement in cycling performance was observed.

In case of Group G2 with a prelithiation degree increased to 19.5%, the prelithiation amount was not only enough to compensate the irreversible Li loss difference between the cathode and the anode, but also extra amount of Li was reserved in the anode to compensate the Li loss during cycling. Hence, the cycle life was greatly improved to 616 cycles.

In case of Groups G3 and G4 with further increased prelithiation degrees, more and more Li was reserved in the anode, so better and better cycling performances were obtained.

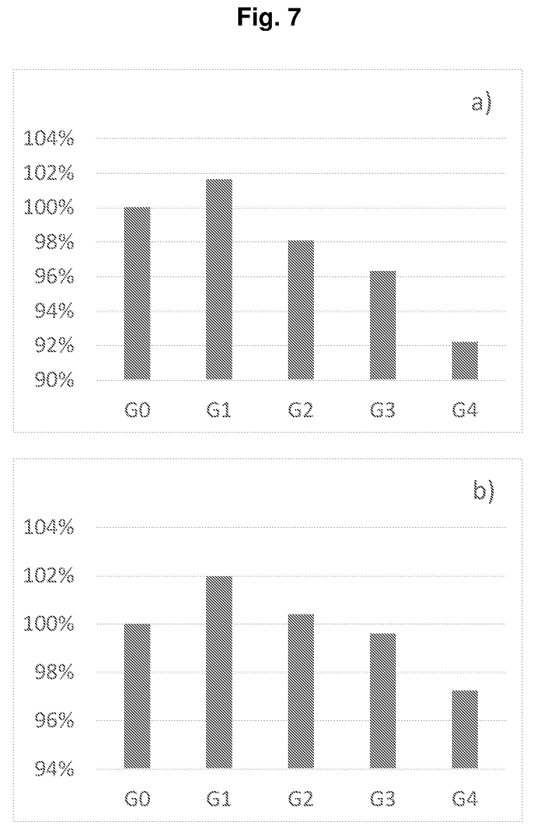

FIG. 7 shows a) the volumetric energy densities and b) the gravimetric energy densities of the full cells of Groups G0, G1, G2, G3, and G4 in Example P1-E1. Compared with non-prelithiation (G0), Group G1 with 5.6% prelithiation degree shows a higher energy density due to the higher capacity. In case of the further increased prelithiation degree for a better cycling performance, the energy density decreases to some extend but still has more than 90% energy density of G0 when prelithiation degree reaches 34.6% in G4.

### Example P1-E2

Example P1-E2 was carried out similar to Example P1-E1, except that HE-NCM was used as the cathode active material and the corresponding parameters were given in Table P1-E2.

TABLE P1-E2

| Group | a | η₁ | b | η₂ | ε | c | x | η_{F} | Life |
|---|---|---|---|---|---|---|---|---|---|
| G0 | 3.04 | 96% | 3.25 | 87% | 0 | 1.00 | 1.07 | 85% | 136 |
| G1 | 3.04 | 96% | 4.09 | 87% | 18.3% | 0.90 | 1.10 | 94% | 231 |
| G2 | 3.04 | 96% | 4.46 | 87% | 26.3% | 0.80 | 1.08 | 95% | 316 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

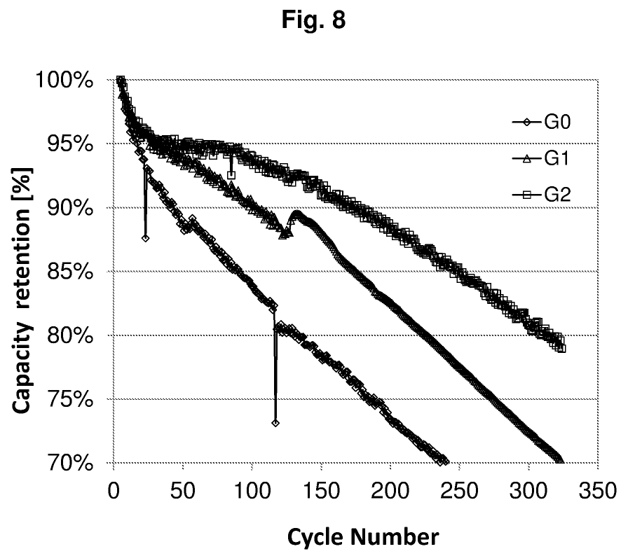

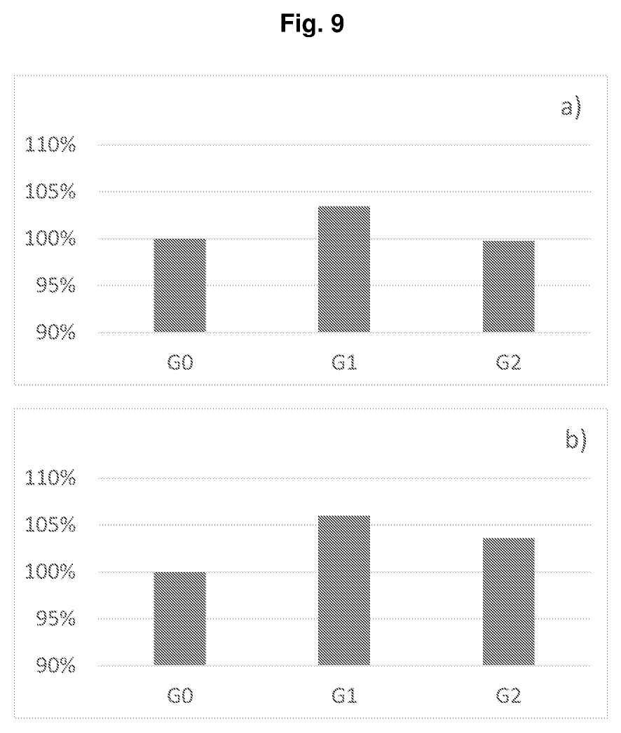

FIG. 8 shows the cycling performances of the full cells of Groups G0, G1, and G2 of Example P1-E2. FIG. 9 shows a) the volumetric energy densities and b) the gravimetric energy densities of the full cells of Groups G0, G1, and G2 of Example P1-E2. It can been seen from Table P1-E2 that the initial Coulombic efficiencies of the full cells were increased from 85% to 95% in case of the prelithiation. Although larger anodes were used for prelithiation, the energy density did not decrease, or even a higher energy density was reached, compared with non-prelithiation in G0. Moreover, the cycling performances were greatly improved, because the Li loss during cycling was compensated by the reserved Li.

### Example P1-E3

Example P1-E3 was carried out similar to Example P1-E1, except that pouch cells were assembled instead of coin cells, and the corresponding prelithiation degrees ε of the anode were a) 0 and b) 22%.

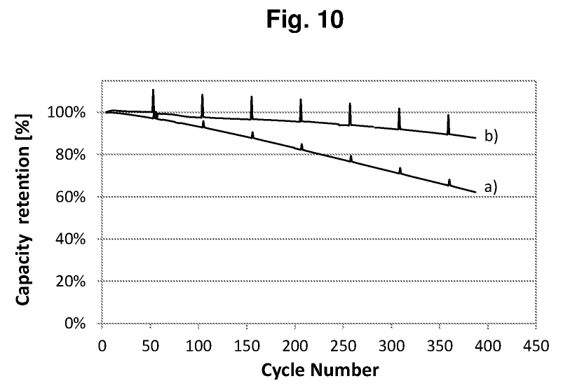

FIG. 10 shows the cycling performances of the full cells of Example P1-E3 with the prelithiation degrees ε of a) 0 and b) 22%. It can been seen that the cycling performance was much improved in case of the prelithiation.

### Examples P2 for Prelithiation

Size of the pouch cell: 46 mm×68 mm (cathode); 48 mm×71 mm (anode);

Cathode: 96.5 wt. % of NCM-111 from BASF, 2 wt. % of PVDF Solef 5130 from Sovey, 1 wt. % of Super P Carbon Black C65 from Timcal, 0.5 wt. % of conductive graphite KS6L from Timcal;

Anode: 40 wt. % of Silicon from Alfa Aesar, 40 wt. % of graphite from BTR, 10 wt. % of NaPAA, 8 wt. % of conductive graphite KS6L from Timcal, 2 wt. % of Super P Carbon Black C65 from Timcal;

Electrolyte: 1M LiPF₆/EC+DMC (1:1 by volume, ethylene carbonate (EC), dimethyl carbonate (DMC), including 30 vol. % of fluoroethylene carbonate (FEC), based on the total nonaqueous organic solvent);

Separator: PP/PE/PP membrane Celgard 2325.

### Comparative Example P2-CE1

A pouch cell was assembled with a cathode initial capacity of 3.83 mAh/cm² and an anode initial capacity of 4.36 mAh/cm² in an Argon-filled glove box (MB-10 compact, MBraun). The cycling performance was evaluated at 25° C. on an Arbin battery test system at 0.1C for formation and at 1C for cycling, wherein the cell was charged to the nominal charge cut off voltage 4.2 V, and discharged to the nominal discharge cut off voltage 2.5 V or to a cut off capacity of 3.1 mAh/cm². The calculated prelithiation degree E of the anode was 0.

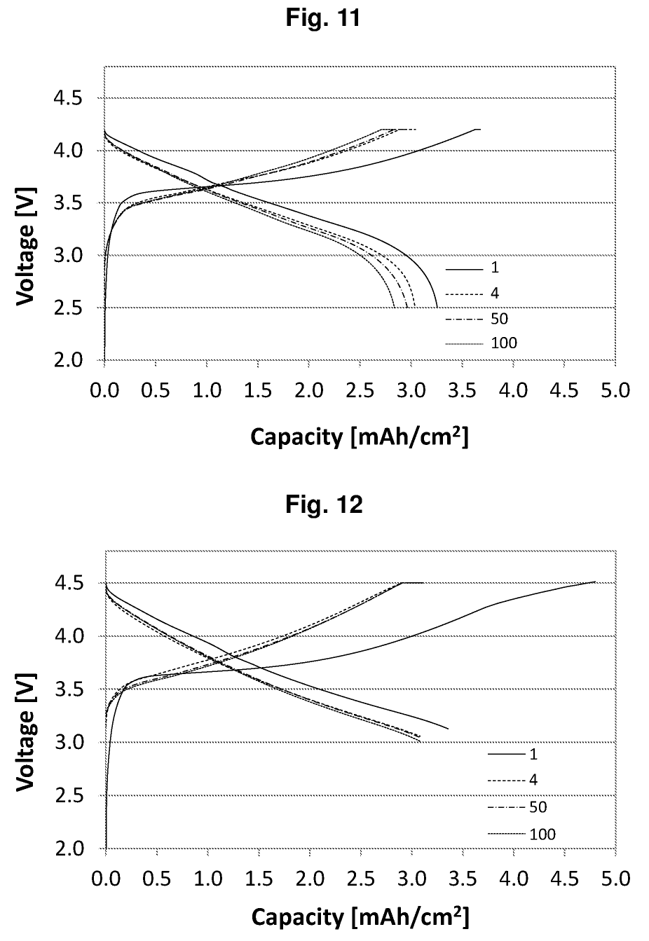

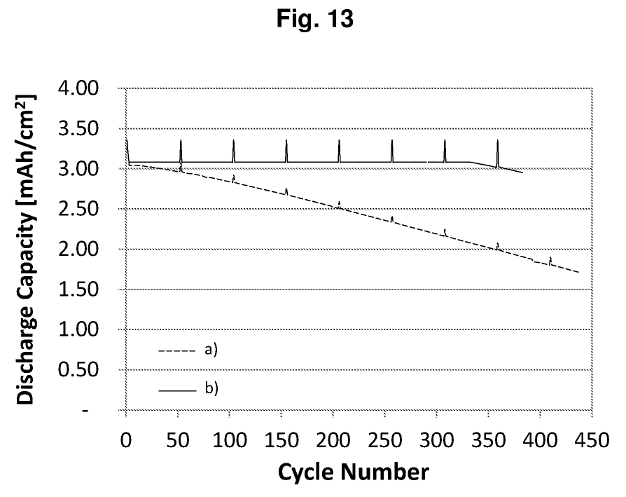

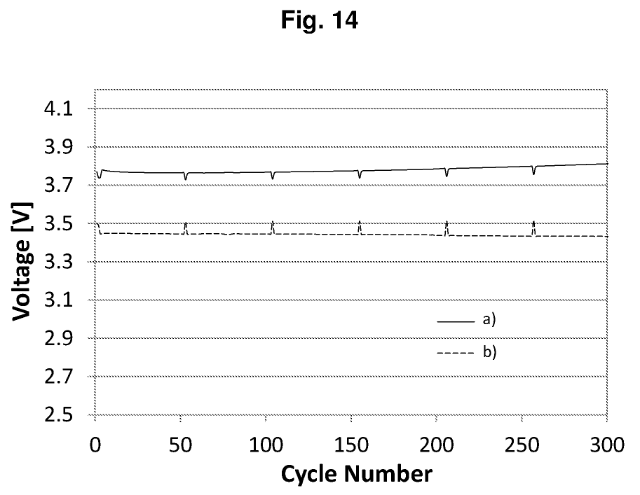

FIG. 11 shows the discharge/charge curve of the cell of Comparative Example P2-CE1, wherein “1”, “4”, “50” and “100” stand for the 1^{st}, 4^{th}, 50^{th} and 100^{th} cycle respectively. FIG. 13 shows the cycling performances of the cells of a) Comparative Example P2-CE1 (dashed line). FIG. 14 shows the average charge voltage a) and the average discharge voltage b) of the cell of Comparative Example P2-CE1.

### Example P2-E1

A pouch cell was assembled with a cathode initial capacity of 3.73 mAh/cm² and an anode initial capacity of 5.17 mAh/cm² in an Argon-filled glove box (MB-10 compact, MBraun). The cycling performance was evaluated at 25° C. on an Arbin battery test system at 0.1C for formation and at 1C for cycling, wherein the cell was charged to a cut off voltage of 4.5 V, which was 0.3 V greater than the nominal charge cut off voltage, and discharged to the nominal discharge cut off voltage 2.5 V or to a cut off capacity of 3.1 mAh/cm². The calculated prelithiation degree E of the anode was 21%.

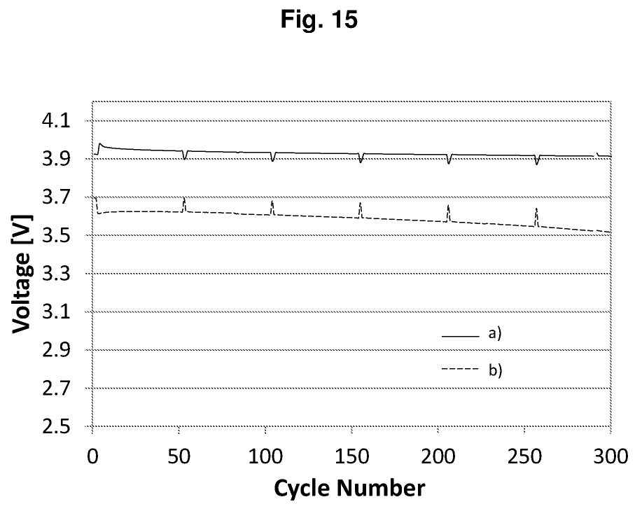

FIG. 12 shows the discharge/charge curve of the cell of Example P2-E1, wherein “1”, “4”, “50” and “100” stand for the 1^{st}, 4^{th}, 50^{th} and 100^{th} cycle respectively. FIG. 13 shows the cycling performances of the cells of b) Example P2-E1 (solid line). FIG. 15 shows the average charge voltage a) and the average discharge voltage b) of the cell of Example P2-E1.

While the disclosure has been described with reference to certain examples, those skilled in the art will appreciate that various modifications, changes, omissions, and substitutions can be made without departing from the spirit of the disclosure. It is intended, therefore, that the present disclosure be limited only by the scope of the following claims.

1. An anode composition for lithium ion batteries, the anode composition comprising:
a) a silicon-based active material; and
b) a binder, wherein the binder is selected from the group consisting of oxystarch, locust bean gum, tara gum, karaya gum and any combination thereof.

2. The anode composition according to claim 1, wherein the silicon-based active material is selected from the group consisting of silicon, silicon alloys, silicon oxides, silicon/carbon composites, silicon oxide/carbon composites and any combination thereof.

3. The anode composition according to claim 1, further comprising: c) a carbon material, wherein the carbon material is selected from the group consisting of carbon black, acetylene black, Ketjen black, graphite, graphene, carbon nanotubes, vapour grown carbon fibers and any combination thereof.

4. The anode composition according to claim 1, further comprising:
a) from 5% to 90% by weight of the silicon-based active material;
b) from 5% to 35% by weight of the binder; and
c) from 0 to 85% by weight of carbon material,
wherein the weight percents of each component are based on the total weight of the anode composition.

5. A process for preparing an anode for lithium ion batteries, comprising:
preparing a slurry by mixing all components of the anode composition according to claim 1 with a solvent; and
applying the slurry onto a current collector.

6. A lithium ion battery, comprising an anode having the anode composition according to claim 1.

7. A lithium-ion battery comprising a cathode, an electrolyte, and an anode, wherein the anode has the anode composition according to claim 1, and the initial surface capacity a of the cathode and the initial surface capacity b of the anode satisfy the relation formulae
1<(b·(1−ε)/a)≤1.2 (I),
0<ε≤((a·η)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

8. The lithium-ion battery of claim 7, characterized in that
ε=((a·η₁)/c−(a−b·(1−η₂)))/b (III),
0.6≤c<1 (IV),
where
c is the depth of discharge of the anode.

9. A method for producing a lithium-ion battery comprising a cathode, an electrolyte, and an anode, wherein the anode is prepared by the process according to claim 5, and said method includes the following steps:
1) prelithiating the active material of the anode or the anode to a prelithiation degree ε, and
2) assembling the anode and the cathode to obtain said lithium-ion battery, characterized in that the initial surface capacity a of the cathode, the initial surface capacity b of the anode, and the prelithiation degree ε satisfy the relation formulae
1<(b·(1−ε)/a)≤1.2 (I),
0<ε≤((a·η)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

10. The method of claim 9, characterized in that
ε=((a·η₁)/c−(a−b·(1−η₂)))/b (III),
0.6≤c<1 (IV),
where
c is the depth of discharge of the anode.

11-17. (canceled)

18. A method for producing a lithium-ion battery comprising a cathode, an electrolyte, and an anode, wherein the anode is prepared by the process according to claim 5, and said method includes the following steps:
1) assembling the anode and the cathode to obtain said lithium-ion battery, and
2) subjecting said lithium-ion battery to a formation process, wherein said formation process includes an initial formation cycle comprising the following steps:
a) charging the battery to a cut off voltage V_{off} which is greater than the nominal charge cut off voltage of the battery, and
b) discharging the battery to the nominal discharge cut off voltage of the battery.

19. The method of claim 18, characterized in that the relative increment r of the initial surface capacity of the cathode over the nominal initial surface capacity a of the cathode and the cut off voltage V_{off} satisfy the following linear equation with a tolerance of ±10%
r=0.75V_{off}−3.134 (V).

20. The method of claim 18, characterized in that the relative increment r of the initial surface capacity of the cathode over the nominal initial surface capacity a of the cathode and the cut off voltage V_{off} satisfy the following quadratic equation with a tolerance of ±10%
r=−0.7857V_{off}²+7.6643V_{off}−18.33 (Va).

21. The method of claim 18, characterized in that the nominal initial surface capacity a of the cathode and the initial surface capacity b of the anode satisfy the relation formulae
1<b·η₂/(a·(1+r)−b·(1−η₂))−ε≤1.2 (I′),
0<ε≤((a·η₁)/0.6−(a−b·(1−η₂)))/b (II),
where
ε is the prelithiation degree of the anode, and
η₂ is the initial coulombic efficiency of the anode.

22. The method of claim 18, characterized in that
ε=((a·η₁)/c−(a−b·(1−η₂)))/b (III),
0.6≤c<1 (IV),
where
η₁ is the initial coulombic efficiency of the cathode, and
c is the depth of discharge of the anode.

23. The method of claim 18, characterized in that the electrolyte comprises one or more fluorinated carbonate compounds as a nonaqueous organic solvent.

24. A lithium-ion battery comprising a cathode, an electrolyte, and an anode, wherein the anode has the anode composition according to claim 1, and the initial surface capacity a of the cathode and the initial surface capacity b of the anode satisfy the relation formulae
1.08≤(b·(1−ε)/a)≤1.12 (Ib),
0<ε≤((a·η₁)/0.6−(a−b*(1−η₂)))/b (II),
where
ε is the prelithiation degree of the anode,
η₁ is the initial coulombic efficiency of the cathode, and
η₂ is the initial coulombic efficiency of the anode.

25. The lithium-ion battery of claim 24, characterized in that
ε=((a·η₁)/c−(a−b(1−η₂)))/b (III),
0.75≤c≤0.85 (IVc),
where
c is the depth of discharge of the anode.

26. A method for producing a lithium-ion battery comprising a cathode, an electrolyte, and an anode, wherein the anode is prepared by the process according to claim 5, and said method includes the following steps:
1) prelithiating the active material of the anode or the anode to a prelithiation degree ε, and
2) assembling the anode and the cathode to obtain said lithium-ion battery, characterized in that the initial surface capacity a of the cathode, the initial surface capacity b of the anode, and the prelithiation degree ε satisfy the relation formulae
1.08≤(b·(1−ε)/a)≤1.12 (Ib),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

27. The method of claim 26, characterized in that
ε=((a·η₁)/c−(a−b·(1−η₂)))/b (III),
0.75≤c≤0.85 (IVc),
where
c is the depth of discharge of the anode.

28. A method for producing a lithium-ion battery comprising a cathode, an electrolyte, and an anode, wherein the anode is prepared by the process according to claim 5, and said method includes the following steps:
1) assembling the anode and the cathode to obtain said lithium-ion battery, and
2) subjecting said lithium-ion battery to a formation process, wherein said formation process includes an initial formation cycle comprising the following steps:
a) charging the battery to a cut off voltage V_{off} which is approximately 0.3 V greater than the nominal charge cut off voltage of the battery, and
b) discharging the battery to the nominal discharge cut off voltage of the battery.

29. The method of claim 28, characterized in that the nominal initial surface capacity a of the cathode and the initial surface capacity b of the anode satisfy the relation formulae
1.08≤b·η₂/(a·(1+r)−b·(1−η₂))−ε≤1.12 (Ib′),
0<ε≤((a≤η₁)/0.6−(a−b·(1−η₂)))/b (II),
where
ε is the prelithiation degree of the anode, and
η₂ is the initial coulombic efficiency of the anode.

30. The method of claim 28, characterized in that
ε=((a·η₁)/c−(a−b·(1−η₂)))/b (III),
0.75≤c≤0.85 (IVc),
where
η₁ is the initial coulombic efficiency of the cathode, and
c is the depth of discharge of the anode.

31. The method of claim 28, characterized in that the electrolyte comprises fluorinated cyclic or acyclic carbonate compounds as a nonaqueous organic solvent.
